(19) United States
(12) Patent Application Publication
(10) Pub. No.: US 2018/0285895 A1
(43) Pub. Date: Oct. 4, 2018

(54) ESTIMATION OF VARIATION OF ATTRIBUTE VALUES OF AGENTS

(71) Applicant: INTERNATIONAL BUSINESS MACHINES CORPORATION, Armonk, NY (US)

(72) Inventors: Akira Azami, Tokyo (JP); Tetsuro Morimura, Tokyo (JP)

(21) Appl. No.: 15/798,715

(22) Filed: Oct. 31, 2017

Related U.S. Application Data
(63) Continuation of application No. 15/472,949, filed on Mar. 29, 2017.

(51) Int. Cl. G06Q 30/02; G06Q 10/08

(52) U.S. Cl. CPC G06Q 30/0201; G06Q 10/087

(57) ABSTRACT

Variation of attribute values of agents are estimated by performing a method including obtaining a first matrix that represents sales records, each sales record including an item among items, a sales event among sales events, and an agent among agents. The first matrix is decomposed into a second matrix that represents first attribute values for each of the sales events, and a third matrix that represents the first attribute values for each of the items. The first attribute values are calculated for an agent among the agents, based on the second matrix, and a variation of the first attribute values for the agent are estimated as caused by a variation of sales records of each of the item among the items.

### TECHNICAL FIELD

The present invention relates to estimation of variation of attribute values of agents.

### RELATED ART

Demand Chain Management (or DCM) is an approach for optimizing product development, production, and distribution of products and/or services based on sales records such as Point-of-Sales (or POS) data. There is a need for methods for predicting and improving performance of sales (such as Key Performance Indicator) based on the sales records with less computational resources.

### SUMMARY

According to a first aspect of the present invention, provided is a method including obtaining a first matrix that represents a plurality of sales records, each sales record including an item among a plurality of items, a sales event among a plurality of sales events, and an agent among a plurality of agents, decomposing the first matrix into a second matrix that represents a plurality of first attribute values for each of the plurality of sales events, and a third matrix that represents the plurality of first attribute values for each of the plurality of items, calculating the plurality of first attribute values of an agent among the plurality of agents, based on the second matrix, and estimating a variation of the plurality of first attribute values of the agent caused by a variation of sales records of each of at least one item among the plurality of items.

The first aspect may also include a computer readable medium storing instructions for causing a processor or programmable circuitry to perform the foregoing method, and an apparatus for performing the foregoing method. The summary clause does not necessarily describe all features of the embodiments of the present invention. Embodiments of the present invention may also include sub-combinations of the features described above.

### BRIEF DESCRIPTION OF THE DRAWINGS

FIG. 1 shows an exemplary configuration of an apparatus, according to an embodiment of the present invention.

FIG. 2 shows an illustrative scheme according to an embodiment of the present invention.

FIG. 3 shows an operational flow according to an embodiment of the present invention.

FIG. 4 shows a first matrix according to an embodiment of the present invention.

FIG. 5 shows a grouped first matrix according to an embodiment of the present invention.

FIG. 6 shows a second matrix according to an embodiment of the present invention.

FIG. 7 shows second matrices according to an embodiment of the present invention.

FIG. 8 shows a third matrix according to an embodiment of the present invention.

FIG. 9 shows a fourth matrix according to an embodiment of the present invention.

FIG. 10 shows first attribute values of agents according to an embodiment of the present invention.

FIG. 11 shows an exemplary hardware configuration of a computer that functions as a system, according to an embodiment of the present invention.

### DETAILED DESCRIPTION

Hereinafter, example embodiments of the present invention will be described. The example embodiments shall not limit the invention according to the claims, and the combinations of the features described in the embodiments are not necessarily essential to the invention.

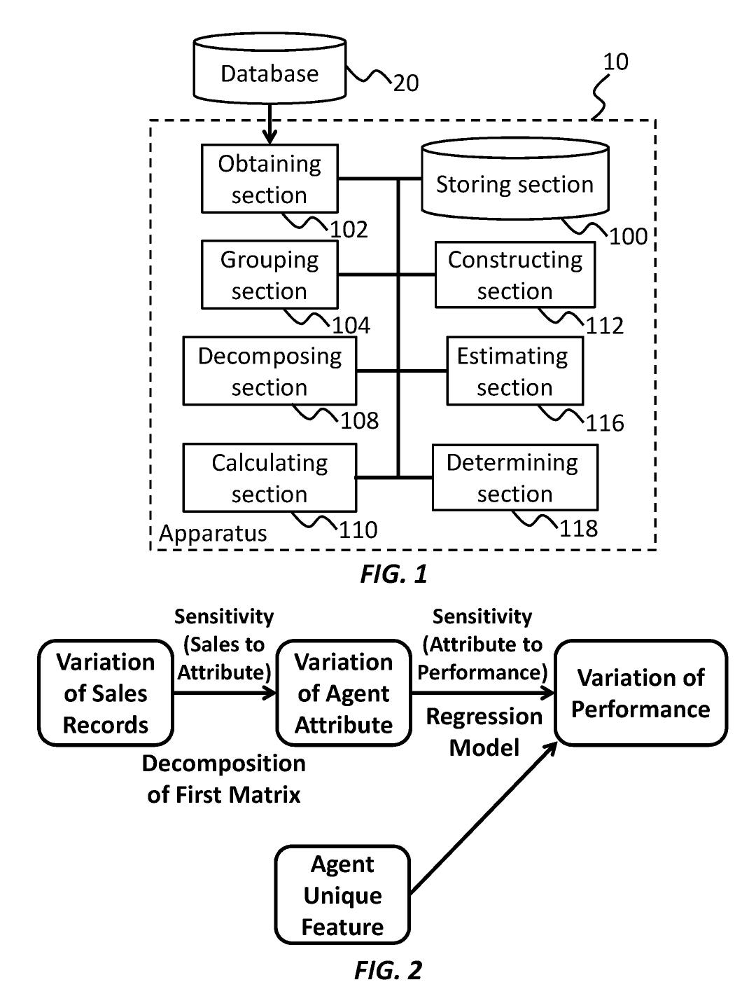

FIG. 1 shows an exemplary configuration of an apparatus 10 (e.g., a computer, a programmable circuit, etc.), according to an embodiment of the present invention. The apparatus 10 may obtain sales records of items from agents, and determine items that have potential to influence performance of the agents.

The apparatus 10 may comprise a processor and/or a programmable circuitry and one or more computer readable mediums collectively including instructions. The instructions, when executed by the processor or programmable circuitry, may cause the processor or the programmable circuitry to operate as a plurality of operating sections. Thereby, the apparatus 10 may be represented as a storing section 100, an obtaining section 102, a grouping section 104, a decomposing section 108, a calculating section 110, a constructing section 112, an estimating section 116, and a determining section 118.

The storing section 100 may store a variety of data used for operations of the apparatus 10. The storing section 100 may comprise a volatile or non-volatile memory. One or more other elements in the apparatus 10 (e.g., the obtaining section 102, the grouping section 104, the decomposing section 108, the calculating section 110, the constructing section 112, the estimating section 116, the determining section 118, etc.) may communicate data directly or via the storing section 100 as necessary.

The obtaining section 102 may obtain a first matrix that represents a plurality of sales records. Each sales record may include an item among a plurality of items, a sales event among a plurality of sales events, and an agent among a plurality of agents. In an embodiment, the sales event may be represented by a receipt, which describes one or more sales records of one or more items at an agent (e.g., a store), and the first matrix may be regarded as a matrix in which sales records of a plurality of receipts are arranged.

The obtaining section 102 may obtain at least a part of Point-Of-Sale (POS) data as the first matrix. The obtaining section 102 may obtain the first matrix from a database 20.

The obtaining section 102 may also obtain a performance of each of the plurality of agents from the database 20. In an embodiment, the plurality of agents may be franchised stores all belonging to a specific franchise, and each performance may be a performance of one of the franchised stores. In an embodiment, the performance of an agent may be a Key Performance Indicator (KPI) of the agent.

The grouping section 104 may group the plurality of items in the first matrix to generate a grouped first matrix. In an embodiment, the grouping section 104 may integrate two or more items into an item group and estimate each sales record for each item group. The grouped first matrix may include a plurality of sales records for the plurality of sales events and the plurality of item groups.

The decomposing section 108 may decompose the first matrix into a second matrix and a third matrix. The decomposing section 108 may decompose the grouped first matrix generated by the grouping section 104 or not-grouped first matrix obtained by the obtaining section 102. The second matrix may represent a plurality of first attribute values for each of the plurality of sales events. The third matrix may represent the plurality of first attribute values for each of the plurality of items (or the plurality of item groups). Details of the decomposition are explained below.

The calculating section 110 may calculate the plurality of first attribute values of an agent among the plurality of agents, based on the second matrix decomposed by the decomposing section 108. In an embodiment, the calculating section 110 may calculate the plurality of first attribute values for each of the plurality of agents.

The constructing section 112 may construct a regression model for estimating the performance of each of the plurality of agents, based on at least the plurality of first attribute values of the each of the plurality of agents calculated by the calculating section 110. In an embodiment, the constructing section 112 may construct the regression model further based on one or more second attribute values that are unique to each of the plurality of agents. Details of the regression model are explained below.

The estimating section 116 may estimate a variation of the performance of each agent among the plurality of agents caused by the variation of sales records of the at least one item, based on the regression model constructed by the constructing section 112. In an embodiment, the estimating section 116 may estimate a variation of the plurality of first attribute values of the agent caused by a variation of sales records of at least one item (e.g., one or more items among an item set including two or more items) among the plurality of items at the agent, and estimate the variation of the performance of the agent based on the estimated variation of the plurality of first attribute values of the agent by utilizing the regression model.

The determining section 118 may determine a first item among the item set that has influenced the performance more than other items among the item set based on the estimated variations of the performance of the agent. In an embodiment, the determining section 118 may determine one item that has the most potential for improving the performance among the plurality of items, as the first item, for each agent of the plurality of agents.

FIG. 2 shows an illustrative scheme according to an embodiment of the present invention. As shown in FIG. 2, a variation of agent attributes (such as the first attribute value) of an agent may be estimated from a variation of sales records of the agents by decomposing the first matrix. The agent attribute may be a characteristic of an agent, as explained below. This may represent sensitivity to the agent attributed by sales records. Then, a variation of performance of the agent may be estimated from the variation of the agent attribute and an agent unique feature (such as the second attribute). This may represent sensitivity to the performance by the agent attribute.

As explained in relation to FIGS. 1-2, the apparatus may estimate the sensitivity to the first attribute value by the sales records and the sensitivity to the performance by the first attribute value, and thereby may predict whether to improve the performance of the agent by changing the sales records of the agents. According to the embodiments, the apparatus may indicate which items should be sold more or less among agents in order to improve the performance

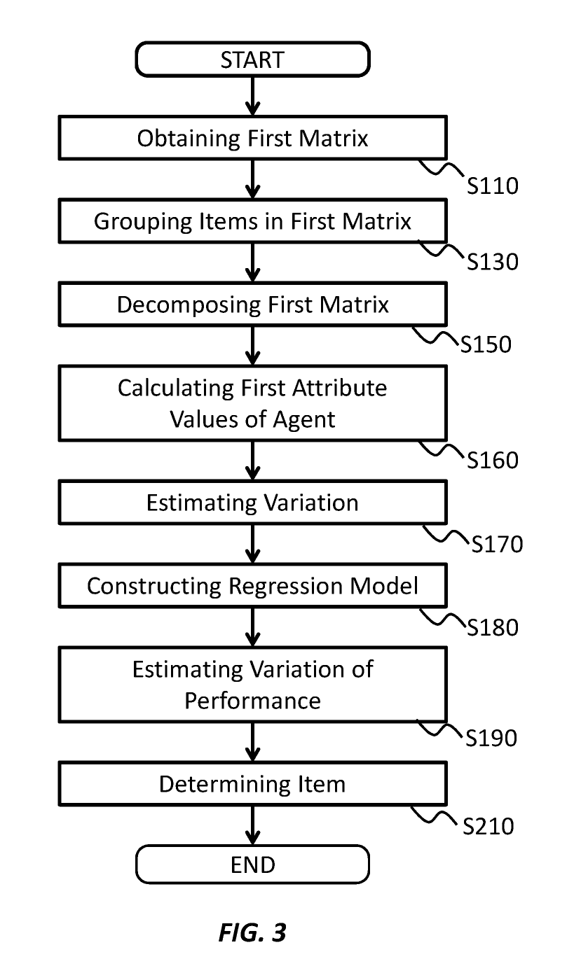

FIG. 3 shows an operational flow according to an embodiment of the present invention. The present embodiment describes an example in which an apparatus, such as the apparatus 10, performs the operations from S110 to S210, as shown in FIG. 3. The apparatus may determine an item that changes the performance of sales by the operations of S110-S210.

At S110, an obtaining section, such as the obtaining section 102, may obtain a first matrix representing a plurality of sales records. In an embodiment, the first matrix may comprise a plurality of rows (or columns) representing the plurality of sales events and a plurality of columns (or rows) representing the plurality of items.

The sales record may be a record of sales of an item made at a sales event. In an embodiment, the sales event may represent an event where one or more items are sold at one agent at one time. In an embodiment, a sales event may be represented by a receipt issued by an agent. In an embodiment, the agent may represent a place(s) and/or an entity(s) that sells item(s). For example, the agent may be one franchised store.

In an embodiment, an item may include paid or free goods and/or services. In the embodiment, the plurality of sales records may represent sales of the item, such as selling goods at a store or on-line, delivering goods/services, renting goods, downloading/streaming software/content, and so on. Each of the plurality of sales records may represent whether or not an item is sold, or, an amount money/quantity/number of the sold item.

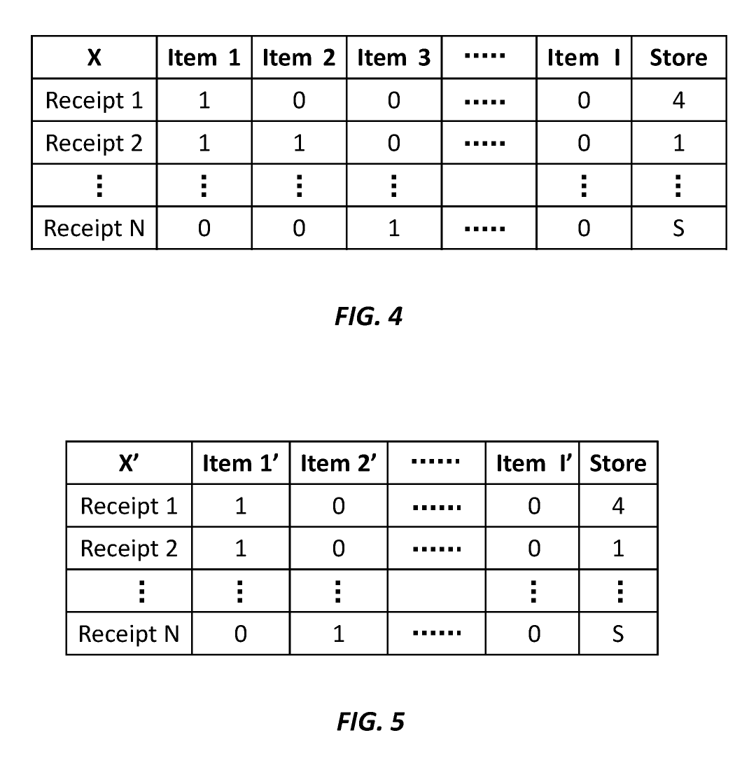

FIG. 4 shows a first matrix according to an embodiment of the present invention. In an embodiment, the obtaining section may obtain the first matrix “X” shown in FIG. 4.

In the embodiment of FIG. 4, the first matrix X comprises “Receipt 1”, “Receipt 2”, . . . , “Receipt N” as the plurality of sales events, and “Item 1”, “Item 2”, . . . , “Item I” as the plurality of items, where N may be the number of the plurality of sales events and I may be the number of the plurality of items. Thereby, the first matrix X is defined as X∈R^{N×I}.

In an embodiment of FIG. 4, the sales records indicate the number of items sold. For example, the first matrix X indicates that one Item 1 is sold at Receipt 1, and one Item 1 and one Item 2 are sold at Receipt 2. In an alternative embodiment, the sales records indicate whether or not an item is sold. For example, the first matrix X indicates that at least one Item 1 is sold but Item 2 is not sold at Receipt 1, and at least one Item 1 and at least one Item 2 are sold at Receipt 2.

The first matrix may also include information of an agent, at which a sales event occurs for each sales event. In the embodiment of FIG. 4, the first matrix X indicates that Receipt 1 is issued at Store 4, Receipt 2 is issued at Store 1, . . . , Receipt N is issued at Store S, where S may be the number of the plurality of agents (e.g., stores).

In an embodiment, the obtaining section may obtain at least part of POS data from a database such as the database 20 as the first matrix, or generate the first matrix based on at least part of POS data.

The obtaining section may also obtain performances of the plurality of agents from the database. In an embodiment, the obtaining section may obtain a KPI of each of the plurality of agents as the performance of each agent. In an embodiment, the KPI of an agent may be an amount of sales of the agent, business profit of the agent, gross profit of the agent, percentage of profit of the agent, inventory turnover, another management indicator, or a combination of two or more of those indicators.

At S130, a grouping section, such as the grouping section 104 may group the plurality of items in the first matrix into item groups to generate a grouped first matrix.

FIG. 5 shows a grouped first matrix according to an embodiment of the present invention. In an embodiment, the grouping section may generate the grouped first matrix “X′” shown in FIG. 5.

In an embodiment, the grouping section may integrate two or more similar items into one item group. The similar items may be (a) substantially the same items that are different only in names, versions, quantities, colors, packages, or the like, (b) items categorized to the same group, or (c) items made by the same or family companies. In an embodiment, the grouping section may initially obtain rules for grouping items from a user of the apparatus and then perform grouping according to the rules.

In an embodiment, the grouping section may estimate each sales record for each item group by adopting the largest sales record among the sales records of the two or more items for each integrated group. In an alternative embodiment, the grouping section may estimate each sales record for each item group by adding sales records of two or more items for the each item group.

In the embodiment of FIG. 5, the grouping section may generate a grouped first matrix X′ including an item group Item 1′ including Item 1 and Item 2 of the first matrix X by adopting the largest value “1” among the sales record “1” of Item 1 at Receipt 1 and the sales record “0” of Item 2 at Receipt 2 as the sales record of Item 1′. The grouped first matrix X′ indicates that at least one item grouped to Item 1′ are sold at Receipt 1. In the embodiment, the grouped first matrix X′ is defined as X′∈R^{N×I′}, where I′ is the number of item groups.

At S150, a decomposing section such as the decomposing section 108 may decompose the grouped first matrix to generate a second matrix, a third matrix, and a fourth matrix. The second matrix may represent a plurality of first attribute values for each of the plurality of sales events. The third matrix may represent the plurality of first attribute values for each of the plurality of items. The fourth matrix may be a diagonal matrix having the same size as the number of the plurality of first attribute values.

In an alternative embodiment, the decomposing section may decompose the not-grouped first matrix obtained at S110 instead of the grouped first matrix obtained at S130 (hereinafter the grouped first matrix and the not-grouped first matrix may be collectively referred to as “first matrix” or “first matrix X”). The decomposing section may decompose the first matrix without the information of the agents (such as the rightmost column of the first matrix in FIG. 5 or FIG. 4). In an embodiment, the decomposing section may decompose the first matrix X into the second matrix U (∈R^{N×D}), the fourth matrix Z (∈R^{D×D}), and the third matrix V(∈R^{D×I′}).

In an embodiment, the decomposing section may decompose the first matrix for only some of the plurality of agents. In the embodiment, the decomposing section may extract sales records of a specific agent (e.g., Store 1) by filtering sales events with the specific agent (e.g., Receipt 2 made at Store 1, . . . ) to generate a filtered first matrix for the specific agent. Then, the decomposing section may decompose the filtered first matrix to generate the second matrix for the specific agent. In an embodiment, the decomposing section may decompose the first matrix for each of the plurality of agents, thereby generating the plurality of second matrices.

The decomposing section may decompose the first matrix with known matrix decomposition methods, such as Matrix Factorization (or MF) or Singular Value Decomposition (or SVD). In an embodiment, the decomposing section may decompose the first matrix based on Non-Negative-Matrix Factorization, thereby reducing computation for decomposition. In particular, Non-Negative Matrix Factorization may reduce computation for the decomposition when the decomposition is needed for only the part of the plurality of agents or the decomposition is performed for each agent of the plurality of agents.

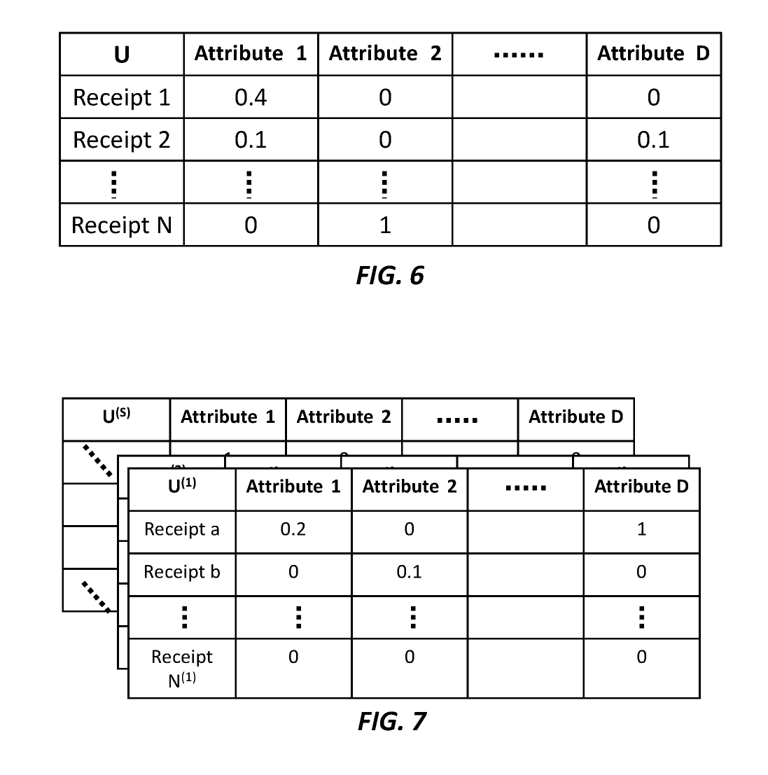

FIG. 6 shows a second matrix according to an embodiment of the present invention. In an embodiment, the decomposing section may obtain the second matrix “U” shown in FIG. 6 by the decomposition of the first matrix X.

In an embodiment, the second matrix may comprise a plurality of rows (or columns) representing the plurality of sales events and a plurality of columns (or rows) representing the plurality of first attribute values.

The plurality of first attribute values may be attributes by which sales records are made. In an embodiment, the plurality of first attribute values may represent shopping minds of buyers by which items are purchased at sales events. The shopping mind may be a latent mission or motive of shopping that the buyers have when buying items. For example, when the second matrix indicates that a sales event has one first attribute value more than 0, items are purchased at the sales event with a shopping mind corresponding to the one first attribute value.

In an embodiment, the shopping minds may be “healthy food”, “eco-friendly”, “bulk buying”, and so on. In an embodiment, the plurality of first attribute values may be construed differently from the shopping minds.

In the embodiment of FIG. 4, the second matrix U represents “Attribute 1”, “Attribute 2”, . . . , “Attribute D” as the plurality of first attribute values. The second matrix U may indicate that a sales event “Receipt 1” is made by “Attribute 1” with the extent of 0.4, and a sales event “Receipt 2” is made by “Attribute 1” with the extent of 0.1 degree.

FIG. 7 shows second matrices according to an embodiment of the present invention. In the embodiment of FIG. 7, the decomposing section decomposes the first matrix for each of S agents, thereby generating S second matrices. Each of S second matrices corresponds to each of S agents. For example, the second matrix U⁽¹⁾ corresponds to Store 1, the second matrix U⁽²⁾ corresponds to Store 2, . . . , the second matrix U^{(S)} corresponds to Store S. In the embodiment of FIG. 7, “Receipt a”, “Receipt b”, . . . , “Receipt N⁽¹⁾” are issued at Store 1.

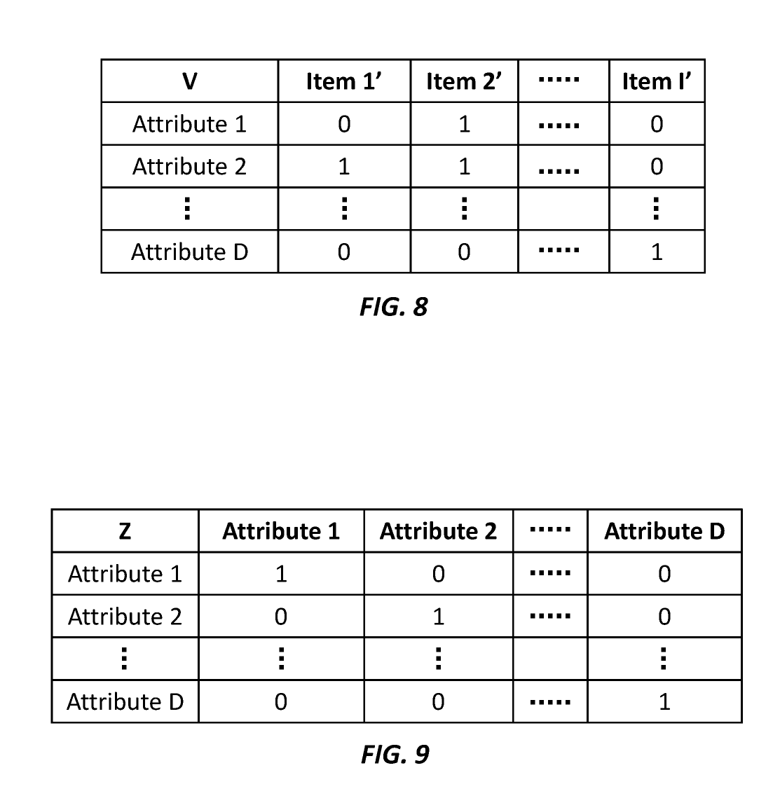

FIG. 8 shows a third according to an embodiment of the present invention. In the embodiment, the decomposing section may obtain the third matrix “V” shown in FIG. 8 by the decomposition of the first matrix X.

In an embodiment, the third matrix may comprise a plurality of rows (or columns) representing the plurality of first attribute values and a plurality of columns (or rows) representing the plurality of item groups (or the plurality of items). In an embodiment, the third matrix may indicate an extent to which each item group (or item) contributes to each first attribute value. For example, an item group including a recycled product(s) may have a higher value of a first attribute value corresponding to “Eco-friendly” than other item groups. In an alternative embodiment, the third matrix may indicate whether or not each item group contributes to each first attribute value.

In the embodiment of FIG. 8, the third matrix V may indicate that Attribute 1 is made of Item 2′ , . . . , Attribute 2 is made of Item 1′, Item 2′ , . . . , and Attribute D is made of . . . Item I′.

FIG. 9 shows a fourth matrix according to an embodiment of the present invention. In an embodiment, the decomposing section may obtain the fourth matrix Z shown in FIG. 9 by the decomposition of the first matrix X. In an embodiment, the number of rows and columns of the fourth matrix may be the same as the number of the plurality of first attribute values. As shown in FIG. 9, the fourth matrix may be a diagonal matrix or a matrix derived from the diagonal matrix having D rows and D columns.

At S160, a calculating section, such as the calculating section 110, may calculate the plurality of first attribute values for each of the plurality of agents based on the second matrix. In an embodiment, the calculating section may calculate an average or a sum of first attribute values of sales events related to each agent for each attribute.

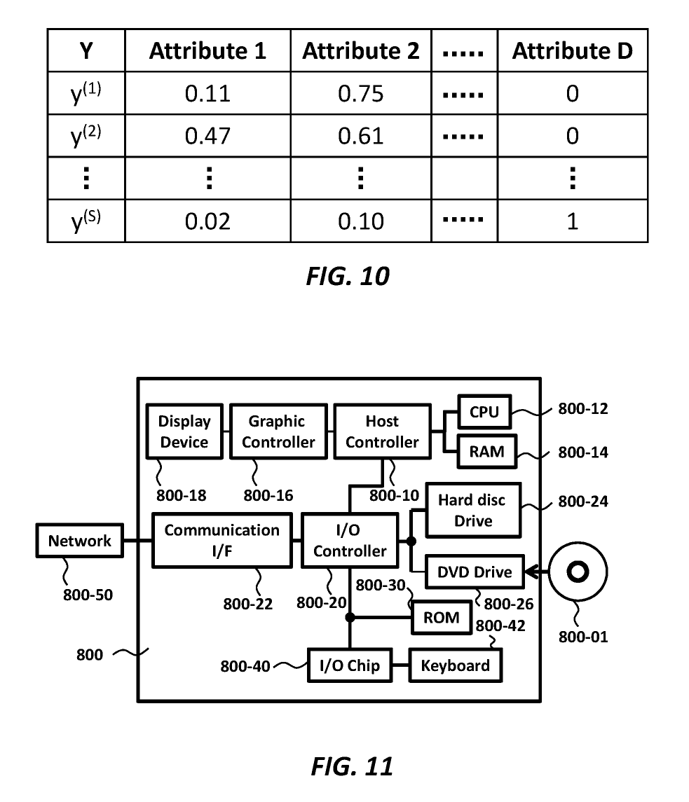

FIG. 10 shows first attribute values of agents according to an embodiment of the present invention. In the embodiment of FIG. 10, the first attribute values for S agents are represented by a matrix Y that includes a vector y⁽¹⁾, a vector y⁽²⁾, . . . , a vector^{(S)}, where a vector (s) represents the first attribute values of an agent s (s∈S).

In an embodiment, the calculating section may estimate an element “0.11” for “Attribute 1” of vector y⁽¹⁾ by calculating an average of the values of “Attribute 1” for “Receipt a” (0.2), “Receipt b” (0), . . . , “Receipt N⁽¹⁾” (0) of U⁽¹⁾ shown in FIG. 7. The calculating section may also estimate an element “0.75” for “Attribute 2” of vector y⁽¹⁾ by calculating a mean value of values of “Attribute 1” for “Receipt a” (0), “Receipt b” (0.1), . . . , “Receipt N⁽¹⁾” (0) of U⁽¹⁾ shown in FIG. 7.

In the embodiment, the estimating section may calculate a vector y^{(s)} by calculating: y^{(s)}=1/N^{(s)}Σₙ[U^{(s)}]_{n,d}, where s represents an agent, N^{(s)} represents the number of sales events of an agent s (i.e. s-th agent), n represents a sales event (n∈N^{(s)}), [U^{(s)}]_{n,d} represents a d-th first attribute value of an n-th sales event in U^{(s)}.

The first attribute values of agents y⁽¹⁾, y⁽²⁾, . . . , y^{(s)} may represent characteristics of each agent. For example, if a value of Attribute 1 (e.g., “Eco-friendly”) of y^{(s)} is higher than that of other agents, then Store s may be considered as having a characteristic of Attribute 1 (“Eco-friendly”) much more than other Stores.

At S170, an estimating section such as the estimating section 116 may estimate a variation of the plurality of first attribute values of the agent caused by a variation of sales records of at least one item of the plurality of items.

In an embodiment, the estimating section may estimate the variation at least partially by decomposing the first matrix with a variation of sales records of at least one item among the plurality of items while fixing the third matrix. According to the embodiment, the estimating section may obtain the second matrix which has changed due to the change of the sales records in the first matrix, while the third matrix and the fourth matrix have not been changed.

In the embodiment, the estimating section may perform the estimation of the variation by differentiating the plurality of first attribute values of the agent with the sales records of the at least one item. For example, the estimating section may calculate the variation of the plurality of attribute values Δy^{(i,s)} by calculating:

Δy^{(i,s}=1/N^{(s)}Σₙ∂[U^{(s)}]ₙ/∂[X]_{n,i}, where i represents an item, s represents an identification of an agent, n represents a sales event, N^{(s)} represents the number of sales events of an agent s, ∂[U^{(s)}]ₙ/∂[X]_{n,i} represents a variation of a vector [U^{(s)}]ₙ corresponding to an n-th sales event of U^{(s)}, caused by a unit improvement of [X]ₙ corresponding a sales record of the i-th item at the n-th sales event. Δy^{(i,s)} may be a vector of the s-th agent having D elements, each of which represents a variation of each first attribute value caused by a variation of sales records of i-th item.

In an embodiment, the unit improvement of a sales record may be a unit improvement of a purchase rate of the i-th item at sales records in U^{(s)}. In the embodiment, the estimating section may generate a varied first matrix X′ by updating sales records of the i-th item in X with the unit improvement of the purchase rate, decompose X′ to obtain a varied U^{(s)}′, and calculate U^{(s)}′−U^{(s)} to obtain Δy^{(i,s}).

In an embodiment, the estimating section may perform the estimation of the variation for all or a part of combinations of the plurality of items and the plurality of agents. In an embodiment, the estimating section may perform the estimation of the variation for all or a part of the plurality of items for a specific agent(s) among the plurality of agents.

At S180, a constructing section, such as the constructing section 112, may construct a regression model for estimating the performance of at least one agent, based on at least the plurality of first attribute values of the at least one agent. In an embodiment, the constructing section may construct a regression model for estimating the performance of each of the plurality of agents, based on at least the plurality of first attribute values of the plurality of agents calculated at S160 and the performance of the plurality of agents obtained at S110.

In an embodiment, the constructing section may construct the regression model, further based on the one or more second attribute values that are unique to each of the plurality of agents in addition to the first attribute values of the plurality of agents. In the embodiment, the second attribute values may be allocated to each of the plurality of agents. In an embodiment, the constructing section may obtain the second attribute values of the agents from a storing section such as the storing section 100, or the obtaining section may obtain the second attribute values of the agents at S110.

In an embodiment, the second attribute values may be independent from sales records of agents. The second attribute values of each agent may represent a location of each agent, a size of agent (e.g., a dimension or capacity of a store), a brand of agent (e.g., a franchise), a climate of agent (e.g., climate on an area of store), a competitor (e.g., existence, distance, and/or scale of competitor), and so on.

The constructing section may construct a linear or non-linear regression model. When the performance (e.g., KPI) of an agent is almost linearly related to the first attribute values (and the second attribute values) of the agent, the constructing section may construct the linear regression model. The regression model may input z^{(s)}, which is defined as z^{(s)}=[y^{(s)}, c^{(s)}] where y^{(s)} is a vector comprising the first attribute values of an agent s, and c^{(s)} is a vector comprising the second attribute values or the second attribute value itself. The regression model may output r(z^{(s)}) as an estimated performance of the agent s.

At S190, the estimating section may estimate a variation of the performance of an agent based on the variation of the first attribute values of the agent estimated at S170 and the regression model constructed at S180.

In an embodiment, the estimating section may estimate z^{(i,s)′}=[y^{(s)}+Δy^{(i,s)}, c^{(s)}] using y^{(s)} calculated at S160 and Δy^{(i,s)} estimated at S170 for the agent s and the item i. In an embodiment, the estimating section may input z^{(i,s)′} into the regression model to obtain r(z^{(i,s)′}), and may input z^{(s)} into the regression model to obtain r(z^{(s)}). In an alternative embodiment, the estimating section may input an actual performance of the agents s obtained at S110 as z^{(s)}, into the regression model. The estimating section may calculate the variation of performance P^{(i,s)}=r(z^{(i,s)′})−r(z^{(s)}) as the estimated variation of the performance of the agent s due to the item i.

The estimating section may estimate P^{(i,s)} for all or a part (e.g., the item set) of the plurality of items for all or a part of the plurality of agents. In an embodiment, the estimating section may estimate P^{(i,s)} for all or a part of the plurality of items for a specific agent s.

At S210, a determining section, such as the determining section 118, may determine the first item among the plurality of items that has influenced the performance more than other items. In an embodiment, the determining section may determine an item that has improved or decreased the performance of an agent the most as the first item for the agent. In an embodiment, the determining section may determine one or more items that have improved or decreased the performance of an agent much more than a threshold as the first item(s) for the agent. The determining section may determine the first item(s) for each of the agents.

In an embodiment, the determining section may determine the first item(s) for the plurality of agents. In an embodiment, the determining section may calculate a sum of P^{(i,s)} of all or a part of the plurality of agents for each item, which may be represented as P⁽¹⁾, P⁽²⁾, . . . , P^{(I)}. In the embodiment, the determining section may determine an item among the plurality of items that has the largest value of p⁽ⁱ⁾ or item(s) that have a value of p⁽ⁱ⁾ larger than a threshold, as the first item(s) for the plurality of agents.

In an alternative embodiment, the constructing section may construct a regression model to estimate a performance of the plurality of agents, inputting the variations of the plurality of first attributes of the plurality of agents. In the embodiment, the determining section may determine the first item(s) by estimating the variation of the performances of the plurality of agents based on the regression model.

As explained in the embodiments in relation to FIGS. 3-10, the apparatus may estimate a variation of performance of agents based on a variation of sales records of the agents. Thereby, for example, the apparatus may predict whether the performance (e.g., KPI) of the agent(s) improves or not, if/when sales of a certain items is changed at the agents.

According to the embodiments, the apparatus reduces the dimensions of the first matrix by converting it to the second matrix, thereby saving computational resources to predict the variation of the performance, compared to a method that directly estimates the performance from the first matrix. This may assist a manager of the agents to determine whether to enhance promotion of certain items at the agent (e.g., a store) for improving the performance, with less computational resources.

Improvement of KPI may not always be simple, because increase of sales of an item (e.g., beverage of a specific brand) may lead to a decrease of sales of another item (e.g., beverage of the other brands). The conventional method may not consider an influence that the increased sales of the certain items have for the overall performance of the agent(s). According to the embodiments of the invention, the apparatus may estimate the improvement of KPI with less computational resources.

In some embodiments, the apparatus may perform a data cleaning for the first matrix X between S110 and S130. In the embodiments, the data cleaning may include deleting, modifying, and/or complementing outlier data, missing data, and/or impossible data (e.g., a negative sales record). In the embodiments, the data cleaning may include reducing the number of rows of the first matrix by merging the plurality of sales events into the less number of sales events.

In some embodiments, the estimating section may perform the estimation of the variation by decomposing the first matrix with a variation of sales records of at least one item among the plurality of items while fixing the second matrix instead of the third matrix at S170, and the constructing section may construct a regression model to estimate the performance with the first and second attribute values as well as the third matrix.

In some embodiments, the estimating section may perform the estimation of the variation by decomposing the first matrix with a variation of sales records of at least one item among the plurality of items without fixing the second matrix and the third matrix at S170.

FIG. 11 shows an exemplary hardware configuration of a computer configured for cloud service utilization, according to an embodiment of the present invention. A program that is installed in the computer 800 can cause the computer 800 to function as or perform operations associated with apparatuses of the embodiments of the present invention or one or more sections (including modules, components, elements, etc.) thereof, and/or cause the computer 800 to perform processes of the embodiments of the present invention or steps thereof. Such a program may be executed by the CPU 800-12 to cause the computer 800 to perform certain operations associated with some or all of the blocks of flowcharts and block diagrams described herein.

The computer 800 according to the present embodiment includes a CPU 800-12, a RAM 800-14, a graphics controller 800-16, and a display device 800-18, which are mutually connected by a host controller 800-10. The computer 800 also includes input/output units such as a communication interface 800-22, a hard disk drive 800-24, a DVD-ROM drive 800-26 and an IC card drive, which are connected to the host controller 800-10 via an input/output controller 800-20. The computer also includes legacy input/output units such as a ROM 800-30 and a keyboard 800-42, which are connected to the input/output controller 800-20 through an input/output chip 800-40.

The CPU 800-12 operates according to programs stored in the ROM 800-30 and the RAM 800-14, thereby controlling each unit. The graphics controller 800-16 obtains image data generated by the CPU 800-12 on a frame buffer or the like provided in the RAM 800-14 or in itself, and causes the image data to be displayed on the display device 800-18.

The communication interface 800-22 communicates with other electronic devices via a network 800-50. The hard disk drive 800-24 stores programs and data used by the CPU 800-12 within the computer 800. The DVD-ROM drive 800-26 reads the programs or the data from the DVD-ROM 800-01, and provides the hard disk drive 800-24 with the programs or the data via the RAM 800-14. The IC card drive reads programs and data from an IC card, and/or writes programs and data into the IC card.

The ROM 800-30 stores therein a boot program or the like executed by the computer 800 at the time of activation, and/or a program depending on the hardware of the computer 800. The input/output chip 800-40 may also connect various input/output units via a parallel port, a serial port, a keyboard port, a mouse port, and the like to the input/output controller 800-20.

A program is provided by computer readable media such as the DVD-ROM 800-01 or the IC card. The program is read from the computer readable media, installed into the hard disk drive 800-24, RAM 800-14, or ROM 800-30, which are also examples of computer readable media, and executed by the CPU 800-12. The information processing described in these programs is read into the computer 800, resulting in cooperation between a program and the above-mentioned various types of hardware resources. An apparatus or method may be constituted by realizing the operation or processing of information in accordance with the usage of the computer 800.

For example, when communication is performed between the computer 800 and an external device, the CPU 800-12 may execute a communication program loaded onto the RAM 800-14 to instruct communication processing to the communication interface 800-22, based on the processing described in the communication program. The communication interface 800-22, under control of the CPU 800-12, reads transmission data stored on a transmission buffering region provided in a recording medium such as the RAM 800-14, the hard disk drive 800-24, the DVD-ROM 800-01, or the IC card, and transmits the read transmission data to network 800-50 or writes reception data received from network 800-50 to a reception buffering region or the like provided on the recording medium.

In addition, the CPU 800-12 may cause all or a necessary portion of a file or a database to be read into the RAM 800-14, the file or the database having been stored in an external recording medium such as the hard disk drive 800-24, the DVD-ROM drive 800-26 (DVD-ROM 800-01), the IC card, etc., and perform various types of processing on the data on the RAM 800-14. The CPU 800-12 may then write back the processed data to the external recording medium.

Various types of information, such as various types of programs, data, tables, and databases, may be stored in the recording medium to undergo information processing. The CPU 800-12 may perform various types of processing on the data read from the RAM 800-14, which includes various types of operations, processing of information, condition judging, conditional branch, unconditional branch, search/replace of information, etc., as described throughout this disclosure and designated by an instruction sequence of programs, and writes the result back to the RAM 800-14.

In addition, the CPU 800-12 may search for information in a file, a database, etc., in the recording medium. For example, when a plurality of entries, each having an attribute value of a first attribute is associated with an attribute value of a second attribute, are stored in the recording medium, the CPU 800-12 may search for an entry matching the condition whose attribute value of the first attribute is designated, from among the plurality of entries, and reads the attribute value of the second attribute stored in the entry, thereby obtaining the attribute value of the second attribute associated with the first attribute satisfying the predetermined condition.

The above-explained program or software modules may be stored in the computer readable media on or near the computer 800. In addition, a recording medium such as a hard disk or a RAM provided in a server system connected to a dedicated communication network or the Internet can be used as the computer readable media, thereby providing the program to the computer 800 via the network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to individualize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As made clear from the above, the embodiments of the present invention enable a learning apparatus learning a model corresponding to time-series input data to have higher expressive ability and learning ability and to perform the learning operation more simply.

What is claimed is:

1. A computer-implemented method comprising:
obtaining a first matrix that represents a plurality of sales records, each sales record including an item among a plurality of items, a sales event among a plurality of sales events, and an agent among a plurality of agents,
decomposing the first matrix into a second matrix that represents a plurality of first attribute values for each of the plurality of sales events, and a third matrix that represents the plurality of first attribute values for each of the plurality of items,
calculating the plurality of first attribute values of an agent among the plurality of agents, based on the second matrix, and
estimating, using a processor, a variation of the plurality of first attribute values of the agent caused by a variation of sales records of at least one item among the plurality of items.

2. The method according to claim 1, further comprising:
constructing a regression model for estimating a performance of each of the plurality of agents based on at least the plurality of first attribute values.

3. The method according to claim 2, wherein the constructing the regression model is based on one or more second attribute values that are unique to each of the plurality of agents.

4. The method according to claim 2, further comprising:
estimating a variation of the performance of an agent among the plurality of agents caused by the variation of sales records of the at least one item, based on the regression model.

5. The method according to claim 4, further comprising:
estimating a variation of the performance of each agent among the plurality of agents caused by the variation of sales records for each item among an item set including the at least one item, based on the regression model, and
determining a first item among the item set that has influenced the performance more than other items among the item set based on the estimated variations of the performance.

6. The method according to claim 1, wherein the decomposing the first matrix includes:
decomposing the first matrix into the second matrix, the third matrix, and a fourth matrix that is a diagonal matrix of the plurality of first attribute values.

7. The method according to claim 6, wherein the decomposing the first matrix includes:
decomposing the first matrix based on non-negative-matrix factorization.

8. The method according to claim 1, wherein the calculating the plurality of first attribute values of the agent includes:
calculating an average of the first attribute values of sales events related to the agent.

9. The method according to claim 1, wherein the estimating the variation of the plurality of first attribute values of the agent is performed by decomposing the first matrix with a variation of sales records of at least one item among the plurality of items while fixing the third matrix.

10. The method according to claim 9, wherein the estimating the variation of the plurality of first attribute values of the agent is performed by differentiating the plurality of first attribute values of the agent with the sales records of the at least one item.

11. The method according to claim 1, further comprising:
grouping the plurality of items in the first matrix to generate a grouped first matrix, and wherein the decomposing the first matrix is performed for the grouped first matrix to generate the second matrix and the third matrix.
